(19) United States
(12) Patent Application Publication
(10) Pub. No.: US 2013/0343427 A1
(43) Pub. Date: Dec. 26, 2013

(54) TEMPERATURE-MEASURING DEVICE WITH A TEMPERATURE-MEASURING SLEEVE FOR MEASURING THE TEMPERATURE OF A FLOWING MEDIUM

(71) Applicants: Rolf-Harald Helmschrott, Wolfratshausen (DE); Anton Wellenhofer, Hohenschaftlarn (DE)

(72) Inventors: Rolf-Harald Helmschrott, Wolfratshausen (DE); Anton Wellenhofer, Hohenschaftlarn (DE)

(21) Appl. No.: 13/925,907

(22) Filed: Jun. 25, 2013

(30) Foreign Application Priority Data
Jun. 26, 2012 (DE) 10 2012 012 740.5

(51) Int. Cl. G01K 13/02

(52) U.S. Cl. CPC G01K 13/02
USPC 374/147

(57) ABSTRACT

The invention relates to a temperature-measuring device for measuring the temperature of a medium flowing through a pipeline segment, wherein the temperature-measuring device consists of a temperature-measuring sleeve introduced into the pipeline segment, in which a temperature sensor is arranged, the temperature-measuring sleeve protruding partially into the pipeline segment, the wall thickness of at least the part of the temperature-measuring sleeve protruding into the pipeline segment being smaller than that of the pipeline segment, the wail thickness and/or the outside diameter of the temperature-measuring sleeve being further reduced in a predetermined area around the temperature sensor.

### BACKGROUND OF THE INVENTION

The invention relates to a temperature-measuring device for measuring the temperature of a medium flowing through a pipeline segment, where the temperature-measuring device consists of a temperature-measuring sleeve introduced into the pipeline segment with a temperature sensor mounted in it.

### STATE OF THE ART

Such temperature-measuring devices are known per se and are installed in pipelines, through which flows a medium whose temperature is to be determined as accurately as possible for upstream and/or downstream process steps. Temperature measurement in the high-pressure field with the great pipe wall thicknesses customary there is especially important.

There are also known temperature-measuring devices in which the temperature sensor is installed without a sheath, i.e., without a temperature-measuring sleeve directly in the flow, in the interior of the pipe. In the event of failure of the sensor wall, however, this leads to the release of medium and/or to contact between the media and the elements from the sensor and/or the sensor wall. In the case of highly explosive or highly reactive media such as hydrogen, this could have fatal consequences. Alternatively, the temperature measurement may also be performed directly on the outside pipe wall. However, the decline in temperature across the pipe wall must be taken into account here. Furthermore, the temperature of the media can only be measured through the pipe wall with a time lag.

With a known generic temperature-measuring device, there is a replaceable temperature sensor in a temperature-measuring sleeve. The wall thickness of the temperature-measuring sleeve is usually more than 5 mm at its thinnest point. When used with comparatively thin pipe inside diameters, it is difficult or even impossible to install such thick-walled temperature-measuring sleeves, and furthermore, the temperature-measuring sleeve installed there causes a great drop in fluid pressure. The lower limit of the pipe inside diameter, down to which installation of such a temperature-measuring sleeve is still possible, is given by the equation: 2*d_{W}−Fd_{S}, where d_{W} is the maximum wall thickness of the temperature-measuring sleeve and d_{S} is the sensor thickness. With d_{W}=5 mm and d_{S}=2 mm, the lower limit for the pipe inside diameter is 12 mm.

Because of the great wall thickness of the temperature-measuring sleeve, this does not offer any recognizable advantage for measuring the temperature on the outer pipe wall—except for the easy replaceability of the sensor.

FIG. 1 shows a known embodiment of the temperature-measuring sleeve described here, labeled as 1. The pipeline segment is a T-piece 4 having a long leg to receive the temperature-measuring sleeve 1. The temperature-measuring sleeve 1, which is also referred to as a pressure sleeve, has an insertion tube 2 for the temperature sensor. The connection 3 or the long leg is widened to receive the pressure sleeve, The possible directions of flow of the medium 5 are indicated by a double arrow.

The design shown here leads to an inferior flow guidance because of the flow resistances and flow rerouting. The temperature-measuring sleeve 1 is usually screwed into a large-volume standard connection 3 (the long leg of the T-piece 4). On the whole, this yields a large dimension. Due to the great free lengths which occur, certain minimum material thicknesses of the temperature-measuring sleeve 1 on the one hand and of the connection 3 on the other hand are necessary to prevent vibrations due to the oncoming flowing medium 5. Another remaining disadvantage is the relatively great minimum wall thickness of the cylindrical temperature-measuring sleeve 1, which tapers toward a tip, as already mentioned above.

The object of the present invention is therefore to provide an improved temperature-measuring device, which allows a rapid and undistorted measurement of the temperature of the medium flowing through the pipeline segment, in particular without having any more negative effect on the fluid dynamics than is absolutely necessary, which would thus produce a great drop in fluid pressure.

### BRIEF SUMMARY OF THE INVENTION

To solve this problem, the invention proposes a temperature-measuring device of the type defined above in which the temperature-measuring sleeve protrudes partially into the pipeline segment, such that the wall thickness of at least the portion of the temperature-measuring sleeve protruding into the pipeline segment is smaller than the pipeline segment, such that the wall thickness and/or the outside diameter of the temperature-measuring sleeve is/are further reduced by the temperature sensor in a given area around the temperature sensor. The invention also relates to the corresponding temperature-measuring sleeve as well as the corresponding pipeline segment, which is designed as a pipeline molded part to receive the temperature-measuring sleeve. Finally, the invention relates to the use of a temperature-measuring device according to the invention for measuring the temperature of hydrogen flowing through the pipeline segment. Additional embodiments of the invention are derived from the respective dependent claims and the following description.

### ADVANTAGES OF THE INVENTION

The temperature-measuring device according to the invention has a temperature-measuring sleeve with a smaller wall thickness in comparison with the pipeline segment, in which the medium whose temperature is to be measured is flowing.

The temperature-measuring sleeve is usually designed so that the outside diameter is less than or equal to the inside diameter of the pipeline segment or it may also be slightly larger for technical reasons pertaining to the connection.

The thin wails of the temperature-measuring sleeve permit a small outside diameter of the temperature-measuring sleeve, which in particular is smaller than or equal to the inside diameter of the pipeline segment and thus on the whole permits a small size of the temperature-measuring device. Due to the fact that the wail thickness and/or the outside diameter is further reduced in a given area around the temperature sensor, a rapid transfer of heat to the temperature sensor is ensured. The area of the further reduced wall thickness and/or the outside diameter is situated at the tip of the temperature-measuring sleeve in particular. It is sufficient if this area of a reduced wall thickness and/or outside diameter, in particular, i.e., the tip of the temperature-measuring sleeve protrudes into the interior of the pipeline segment in order to measure the temperature of the medium there. It is possible in this way that only a small amount of the temperature-measuring sleeve protrudes into the interior of the pipe. A short free tip of the temperature-measuring sleeve which protrudes into the interior of the pipe is advantageous. Such a design is small and vibration-resistant and has hardly any effect on the flow. The wall thickness of the short free tip can be reduced to the minimum required wail thickness, which depends on the strength of the selected material and the operating conditions. For reasons pertaining to fluid mechanics and heat transfer, a ratio of the outside diameter of the tip to the inside diameter of the pipe segment of less than or equal to 0.75 should be the goal.

It is especially advantageous if the temperature-measuring sleeve is high-pressure-resistant and/or made of a high-strength material, which leads to a reduction in the minimum required wall thickness of the temperature-measuring sleeve and thus of the total diameter of the temperature-measuring sleeve.

The temperature-measuring sleeve may advantageously be designed to have a smaller outside diameter at the same sensor thickness d_{S} than that of the pipeline segment, in particular smaller than the wall thickness of the pipeline segment, This allows the introduction of the temperature-measuring sleeve into pipes with a smaller inside diameter than was possible in the past.

It is advantageous in particular if the temperature-measuring sleeve extends through the wall of the pipeline segment into an area about the axis of the pipeline segment into the interior of same. For example the tip of the temperature-measuring sleeve or the center of the area of the temperature-measuring sleeve whose wall thickness has been further reduced may extent to the axis or essentially to the axis of the pipeline system. The axis of the pipeline system here refers to the longitudinal axis. In contrast with the state of the art, the temperature-measuring sleeve thus does not fill up large areas of the interior of the pipe but instead protrudes a small distance at its tip, starting from the inside wall of the pipe, preferably to the center of the interior space. This leads to a stable arrangement, which also influences the flow as little as possible and has a minor drop in fluid pressure.

It is advantageous if the axis of the temperature-measuring sleeve, which is essentially cylindrical in particular, is at an acute angle to the axis of the pipeline segment mentioned above, based on the direction of flow of the medium. In the case of a slightly decentralized arrangement, the acute angle is between the axis of the temperature-measuring sleeve and a straight line parallel to the axis of the pipeline segment. The tip of the temperature-measuring sleeve is thus exposed to the oncoming flow of the medium at an acute angle. If the tip is approximately at the center of the pipe, this ensures an optimal temperature measurement.

The invention also relates to a temperature-measuring sleeve which can be introduced into a pipeline segment, having the features described above in conjunction with the temperature-measuring device according to the invention. The temperature-measuring sleeve is secured in the pipeline segment in a counterpart which is designed accordingly, e.g., preferably being screwed and/or welded tightly by means of a clamp ring connection.

The invention also relates to a pipeline segment of a temperature-measuring device according to the invention as described above, such that this pipeline segment is designed as a molded pipeline component to receive a temperature-measuring sleeve according to the invention. The molded pipeline component is also referred to as a fitting. This is a component which is inserted into a pipeline in which the medium flows whose temperature is to be measured. It is advisable here if a flange is provided to receive the temperature-measuring sleeve in the molded pipeline component such that this flange is preferably designed in one piece with the molded component. The flange has an opening for insertion of the temperature-measuring sleeve into the interior of the molded component. If the axis of the temperature-measuring sleeve is at an angle to the axis of the pipeline segment and/or the molded component, then the flange opening is advantageously oriented accordingly.

It is advantageous if the inside diameter of the molded pipeline component is designed to be larger in an environment of the flange than outside of this environment. This environment of the flange may extend over most of the length in the interior of the molded pipeline component, so that only the end piece of the molded pipeline component has the smaller inside diameter. With this design, it is possible to weight the options between a greater drop in fluid pressure and a faster reaction of the temperature sensor due to the improved heat transfer to the sensor and a low drop in fluid pressure with a reduced heat transfer at the same time.

Finally, the temperature-measuring device according to the invention is especially suitable for measuring the temperature of hydrogen flowing through the pipeline segment and/or the molded pipeline component.

The molded pipeline component to receive the temperature-measuring sleeve has the following advantages and properties in summary:
vibration-resistant design because only the free tip of the temperature-measuring sleeve protrudes into the interior;
the sensor tip is in the flow;
small design size of the molded pipeline component and of the assembled temperature-measuring device;
straight-flow guidance possible (no T-piece required);
constriction of the flow cross section possible at the sensor site for increased transfer due to the increased velocity;
enlarged flow cross section for adaptation of the flow-pressure drop and heat transfer for optimization;
possible to design it as a bypass having small dimensions in the case when the available space is restricted.

To summarize once again, here are the advantages of the invention and its embodiments:
minimal pressure drop due to small interfering body (tip of the temperature-measuring sleeve) in the flow;
straight flow through the pipeline measuring segment without deflection of the flow possible is possible;
rapid temperature adjustment due to the high thermal conduction due to the small wall thickness of the sleeve;
high measurement accuracy with a high compressive strength at the same time;
replaceable temperature sensor without being open to the process (without access to the interior of the pipe);
high vibrational strength due to small interfering body (tip of the temperature-measuring sleeve) in the flow and guidance in the molded pipeline component;
high degree of imperviousness due to being manufactured from a solid piece or due to tight welding;
small total size therefore simple installation.

In addition to using the present invention in the high-pressure field, it is also especially suitable for temperature measurements in the low-pressure range and in the area of use of media with high requirements of imperviousness (toxic, reactive, inflammatory media; foods; pharmaceutical products), in particular when there is a demand for rapid and accurate temperature measurement and/or replaceability of the temperature sensor without having any effect on the process.

It is self-evident that the features mentioned above and those yet to be explained below may be used not only in the particular combination given but also in other combinations or alone without going beyond the scope of the present invention.

### BRIEF DESCRIPTION OF THE DRAWINGS

The present invention is diagrammed schematically in the drawings on the basis of exemplary embodiments:

FIG. 1 shows schematically a temperature-measuring device according to the state of the art;

FIG. 2 shows schematically an embodiment of a temperature-measuring device according to the invention with a temperature-measuring sleeve;

FIG. 3 shows an embodiment of a molded pipeline component that is used for the device according to Figure, and

FIG. 4 shows an embodiment of a temperature-measuring sleeve that is used for the device according to FIG. 1.

### DETAILED DESCRIPTION OF THE INVENTION

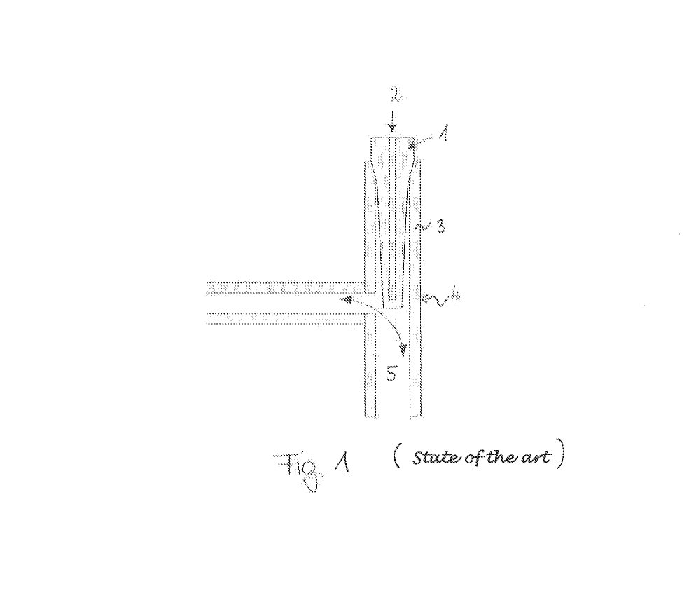

FIG. 1 has already been explained in the introduction to the description.

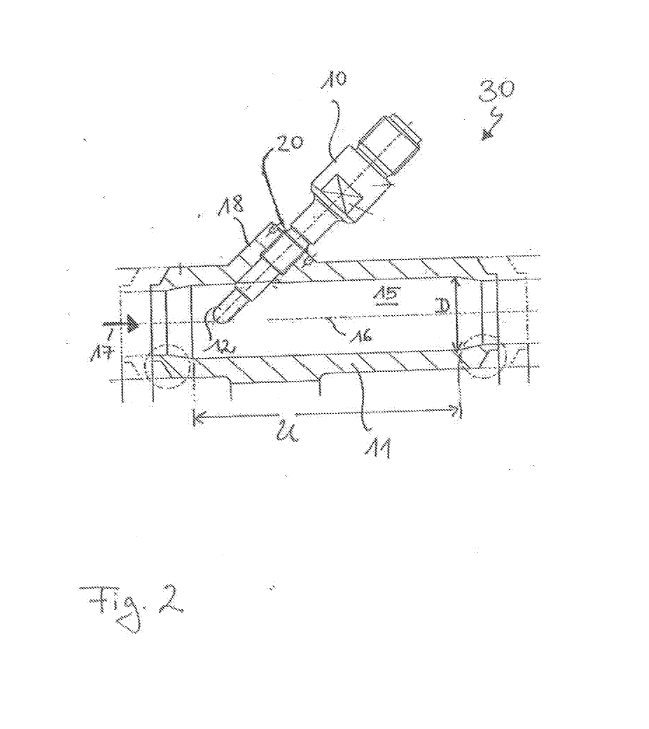

FIGS. 2 through 4 have been described in general. The same reference numerals indicate the same elements.

FIG. 2 shows a temperature-measuring device 30 with a pipeline segment 11 and a temperature-measuring sleeve 10. The pipe interior 15 of the pipeline segment 11 has a medium 5 such as hydrogen flowing through it in the direction of flow 17. The longitudinal axis of the pipeline segment 11 is labeled as 16. The temperature-measuring sleeve 10 is inserted at its front part into a flange 18 (welded here). The tight-welded seam is labeled as 20. A front part of the temperature-measuring sleeve 10 protrudes into the interior 15 of the pipe. The tip of the temperature-measuring sleeve 10 is labeled as 13. It is completely in the interior 15 of the pipe. A temperature sensor (not shown) is arranged in the interior of the temperature-measuring sleeve 10.

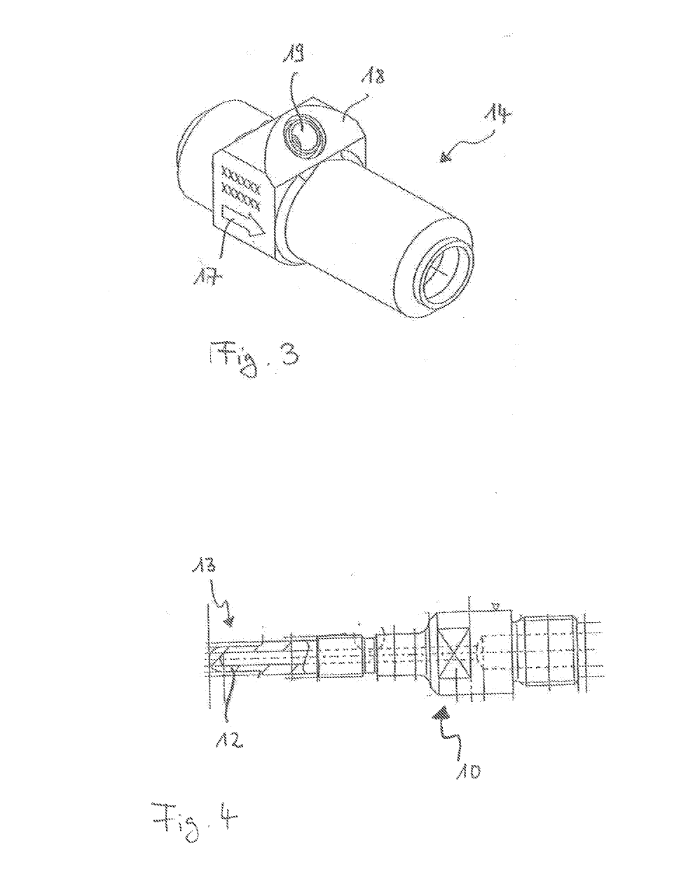

The pipeline segment 11 shown in FIG. 2 may be a molded pipeline component 14, which is also referred to as a holding fitting, as shown in FIG. 3, The molded pipeline component 14 is inserted into the pipeline in which the medium is flowing. The component 14 has a flange 18, which in turn has an opening 19 to receive the temperature-measuring sleeve 10. The flange 18 is preferably designed in one piece with the molded part 14. The direction of flow of the medium is again labeled as 17.

FIG. 4 shows the temperature-measuring sleeve from FIG. 2 in detail. In particular the front area of the temperature-measuring sleeve 10 with its tip 13 is visible here. FIG. 4 shows in particular the diameter of the temperature-measuring sleeve 10 and these diameters are comparable to the diameters of the pipeline segment 11 from FIG. 2. The outside diameter of the temperature-measuring sleeve 10 is smaller than, equal to or not much larger than the inside diameter of the pipeline segment 11 in its front area. In a given area 12 around the tip of the temperature sensor, the diameter and the wall thickness are reduced again, as shown in FIG. 4. The area 12, the wall thickness of which has been reduced again, protrudes completely into the pipe interior 15 as shown in FIG. 2. Therefore, a rapid, distortion-free temperature measurement is made possible, so that it forms a compact design, is vibration-proof and is hardly affected at all by the flow. The ratio of the outside diameter of the tip to the inside diameter of the pipeline segment is designed to be ≦0.75.

The temperature-measuring sleeve 10 is also designed with a smaller outside diameter than that of the pipeline segment 11. This allows the temperature-measuring sleeve 10 to be introduced into pipes having a very small inside diameter.

The axis of the temperature-measuring sleeve 10 forms an acute angle with the axis 16 of the pipeline segment 11 based on the direction of flow 17, with the tip 12 of the temperature-measuring sleeve 10 extending approximately as far as the longitudinal axis 16, This permits an accurate temperature measurement while at the same time having a minor influence on the fluid dynamics.

FIG. 2 also shows that the inside diameter D of the pipeline segment 11 and/or of the molded pipeline component 14 (cf. FIG. 3) is designed to be larger in the environment U of the flange 18, for example, than outside of this environment on the end pieces of the pipeline segment 11. The flow velocity here was optimized to the heat transfer toward the process requirement.

One possible area of use is with gaseous and liquefied gases, e.g., hydrogen and helium at pressures up to 1000 bar. In the shipping industry, trailers are operated at pressures up to 500 bar. In the automotive field, H₂ fuelling stations have been built for refilling tanks at up to 700 bar. Compressors up to 1000 bar are used for compression in the gaseous/liquid medium state.

Typical pipe inside diameters are from 5 mm to 25 mm. Measurement of the temperature of the medium is used here to define the maximum filling pressure of the trailer/automotive. The most rapid and most reliable possible temperature display is essential for correct and reliable operation. The measurement range of the temperature measurement is in the range of 4 Kelvin to 373 Kelvin. In a temperature measurement at 1000 bar, DN 15, the thickness of the pipe wall of the segment 11 is 5.5 mm and the pipe wall thickness of the area 12 of the tip is 1.6 mm.

### LIST OF REFERENCE NURSE

1 temperature-measuring sleeve

2 insertion pipe

3 connection

4 T-piece

5 medium

10 temperature-measuring sleeve

11 pipeline segment

12 area around the temperature sensor

13 tip

14 molded pipeline component

15 pipe interior

16 axis of the pipeline segment

17 direction of flow

18 flange

19 opening

20 sealing weld

30 temperature-measuring device

D inside diameter

U environment or surroundings

1. A temperature-measuring device for measuring the temperature of a medium flowing through a pipeline segment, wherein the temperature-measuring device includes a temperature-measuring sleeve introduced into the pipeline segment in which a temperature sensor is arranged, wherein the temperature-measuring sleeve protrudes partially into the pipeline segment, the wall thickness of at least the part of the temperature-measuring sleeve protruding into the pipeline segment being smaller than that of the pipeline segment, the outside diameter of the temperature-measuring sleeve being further reduced in a predetermined area around the temperature sensor.

2. The temperature-measuring device according to claim 1 wherein the area of of reduced outside diameter is created by reducing the wall thickness of the temperature-measuring sleeve.

3. The temperature-measuring device according to claim 1, wherein the predetermined area is at the tip of the temperature-measuring sleeve.

4. The temperature-measuring device according to claim 3, wherein the temperature-measuring sleeve together with the predetermined area at the tip protrudes completely into the interior of the pipeline segment.

5. The temperature-measuring device according to claim 1 wherein the temperature-measuring sleeve is designed to have a have high pressure resistance.

6. The temperature-measuring device according to claim 1 wherein the temperature-measuring sleeve is made of a high-strength material.

7. The temperature-measuring device according to claim 1 wherein the outside diameter of the portion of the temperature-measuring sleeve protruding into the pipeline segment is smaller than that of the pipeline segment.

8. The temperature-measuring device according to claim 7 wherein the outside diameter of the portion of the temperature-measuring sleeve protruding into the pipeline segment is smaller than or equal to the inside diameter of the pipeline segment.

9. The temperature-measuring device according to claim 8 wherein the outside diameter of the portion of the temperature-measuring sleeve protruding into the pipeline segment is smaller than or equal to the wall thickness of the pipeline segment.

10. The temperature-measuring device according claim 1 wherein the temperature-measuring sleeve extends into an area around the axis of the pipeline segment into the interior of the pipeline segment.

11. The temperature-measuring device according to claim 1 wherein the temperature-measuring sleeve is cylindrical.

12. The temperature-measuring device according to claim 11 wherein the axis of the temperature-measuring sleeve based on the direction of flow of the medium flowing in the pipeline segment, forms an acute angle to the axis of the pipeline segment.

13. The temperature-measuring device according to claim 11 wherein the axis of the temperature-measuring sleeve forms an acute angle to a straight line that is parallel to the axis of the pipeline segment.

14. The temperature-measuring device according to claim 1 wherein the pipeline segment is designed as a molded pipeline component to receive the temperature-measuring sleeve.

15. The temperature-measuring device according to claim 14 wherein the molded pipeline component has a flange to receive the temperature-measuring sleeve.

16. The temperature-measuring device according to claim 15 wherein the inside diameter of the molded pipeline component in the vicinity of the flange is designed to be greater than the diameter of the molded pipeline outside of the vicinity of the flange.

17. The temperature-measuring device according to claim 1 wherein the temperature-measuring sleeve is used for measuring the temperature of hydrogen flowing through the pipeline segment.
